(19) United States
(12) Patent Application Publication
(10) Pub. No.: US 2014/0136423 A1
(43) Pub. Date: May 15, 2014

(54) METHODS AND SYSTEM FOR WARRANTY REGISTRATION AND PROCESSING

(71) Applicant: Paul Y. Moreton, Glen Allen, VA (US)

(72) Inventor: Paul Y. Moreton, Glen Allen, VA (US)

(73) Assignee: Capital One Financial Corporation, McLean, VA (US)

(21) Appl. No.: 14/043,451

(22) Filed: Oct. 1, 2013

Related U.S. Application Data
(60) Provisional application No. 61/725,609, filed on Nov. 13, 2012.

(51) Int. Cl. G06Q 30/00

(52) U.S. Cl. CPC G06Q 30/012
USPC 705/302

(57) ABSTRACT

Disclosed embodiments generally relate to the registration of product warranties. More particularly, the disclosed embodiments relate to systems and methods for enhancing and optimizing the ability to process warranty registrations. In one aspect, the disclosed embodiments include a processor-implemented warranty management method. In one embodiment, one or more processors may receive, from a mobile device, a product purchase receipt image. The processors may use optical character recognition to extract product purchase data from the product purchase receipt image. In another aspect, the processor may identify, by parsing the product purchase data, one or more product warranty terms including a product warranty time. In yet another aspect, the processors may generate a product warranty data structure comprising the one or more product warranty terms. The processors may provide the product warranty data structure for storage in a memory device.

### PRIORITY CLAIM

This disclosure claims priority under 35 U.S.C. §119 to U.S. provisional patent application No. 61/725,609, filed on Nov. 13, 2012, and entitled “Methods and System for Warranty Registration and Processing,” which is incorporated herein by reference in its entirety.

### FIELD

Disclosed embodiments generally relate to the registration of product warranties. More particularly, the disclosed embodiments relate to systems and methods for enhancing and optimizing the ability to process warranty registrations.

### BACKGROUND

Goods and services often carry a manufacturer's warranty that entitles the consumer to some form of remedy should specific conditions become met for a certain period of time. For example, if a product is found to be defective during the warranty period, the manufacturer may replace the product or refund the purchase price. Many credit card companies have instituted their own warranty programs as a customer incentive. These programs reward consumers for using a particular credit card to purchase goods by offering additional warranties. Current systems, however, often require the customer to gather and send numerous documents to the credit card company to register the warranties in these programs. The frustrations associated with

warranty registration often result in fewer registrations, resulting in lower value for the customer incentive program.

For example, consumers typically register for the additional warranty service by calling the credit card company and/or mailing copies of the store receipt and warranty information to the credit card company. Once registered, the user must keep the original documents for the duration of the additional warranty and resubmit them to file a claim. Such a combination of tasks becomes increasingly difficult as time goes by and the consumer purchases more goods.

### SUMMARY

Methods and systems consistent with the disclosed embodiments provide robust and efficient registration of product warranties, including streamlined data gathering and organization, dynamic warranty registration through a hassle-free mobile interface, and meaningful reporting abilities. Additionally, embodiments of the present disclosure provide valuable data to credit card companies and other financial service providers, such as product information and customer purchasing habits.

Additional objects and advantages will be set forth in part in the description which follows, and in part will be obvious from the description, or may be learned by practicing embodiments of the present disclosure. The objects and advantages will be realized and attained by means of the elements and combinations particularly pointed out in the appended claims.

Consistent with disclosed embodiments, methods are provided for registering and managing warranties for items purchased by a financial service provider (FSP) customer. In some embodiments, an FSP system may receive receipt information associated with a product purchased by a customer using a financial account. The FSP system may determine warranty terms for the product based on the receipt information and determine a warranty time period based on the warranty terms. Based on the warranty time period, the FSP system may determine an extended warranty time period.

In some embodiments, a system for providing an extended warranty may comprise one or more processors and one or more memory devices having instructions stored thereon. When executed, the instructions may cause the one or more processors to perform disclosed methods.

In one aspect, the disclosed embodiments include a warranty management system. The system may comprise one or more processors; and one or more memory devices storing processor-executable instructions. In one aspect, according to the instructions, the processors may receive, from a mobile device, a product purchase receipt image. In another aspect, the processor may extract, using optical character recognition, product purchase data from the product purchase receipt image. In another aspect, the processors may identify, by parsing the product purchase data, one or more product warranty terms including a product warranty time. In yet another aspect, the processor may generate a product warranty data structure comprising the one or more product warranty terms. A memory device may store the product warranty data structure.

In one aspect, the disclosed embodiments include a processor-implemented warranty management method. The method may include receiving, from a mobile device, a product purchase receipt image. In one aspect, the method may include extracting, using optical character recognition by one or more processors, product purchase data from the product purchase receipt image. The method may further include identifying, by parsing the product purchase data by the one or more processors, one or more product warranty terms including a product warranty time. In another aspect, the method may include generating, via the one or more processors, a product warranty data structure comprising the one or more product warranty terms. The product warranty data structure may be stored in a memory device.

In one aspect, the disclosed embodiments include a warranty claim processing system. The system may comprise one or more processors, and one or more memory devices storing processor-executable instructions. In one aspect, according to the instructions, the processors may receive a warranty claim request. In another aspect, the processors may extract product and customer identification information from the warranty claim request. The processors may query a database for manufacturer or vendor product warranty data related to the product and customer identification information. In another aspect, the processor may determine whether a manufacturer or vendor product warranty is effective, based on a result of the database query for the manufacturer or vendor product warranty data. In yet another aspect, the processors may generate a populated warranty claim form using the extracted product and customer identification information and the result of the database query. The processors may provide the populated warranty claim form to a computer associated with a warranty provider.

### BRIEF DESCRIPTION OF THE DRAWINGS

The accompanying drawings, which are incorporated in and constitute a part of this disclosure, illustrate various disclosed embodiments, and together with the description, serve to explain the principles of the embodiments. In the drawings:

FIG. 1 is a diagram of an example system for registering warranties over a network consistent with disclosed embodiments;

FIG. 2 illustrates exemplary system components consistent with disclosed embodiments;

The flowchart in FIGS. 3A-3C illustrate an exemplary warranty registration process, consistent with disclosed embodiments; and

The flowchart in FIGS. 4A-4C illustrate an exemplary warranty claim process consistent with disclosed embodiments.

### DESCRIPTION OF THE EMBODIMENTS

The following detailed description refers to the accompanying drawings. Wherever possible, the same reference numbers will be used throughout the drawings to refer to the same or like parts. While several exemplary embodiments and features of the invention are described herein, modifications, adaptations and other implementations are possible, without departing from the spirit and scope of disclosed embodiments. For example, substitutions, deletions, additions, or modifications may be made to the components illustrated in the drawings, and the exemplary methods described herein may be modified by substituting, deleting, reordering, or adding steps to the disclosed methods. Accordingly, the following detailed description does not limit the invention. Instead, the proper scope of the invention is defined by the appended claims.

Methods and systems consistent with disclosed embodiments may provide for simplified online registration of warranties. Users may purchase goods that contain a manufacturer and/or merchant's warranty with a credit card that allows for additional warranty coverage. Disclosed embodiments include methods and systems for registering warranties with reduced user involvement. For example, a server operated by a financial service provider may receive receipt and/or warranty information associated with a user purchase. Data may be extracted from the received information to recognize the particular products or services purchased, determine warranties associated with the items, and register warranties for the items.

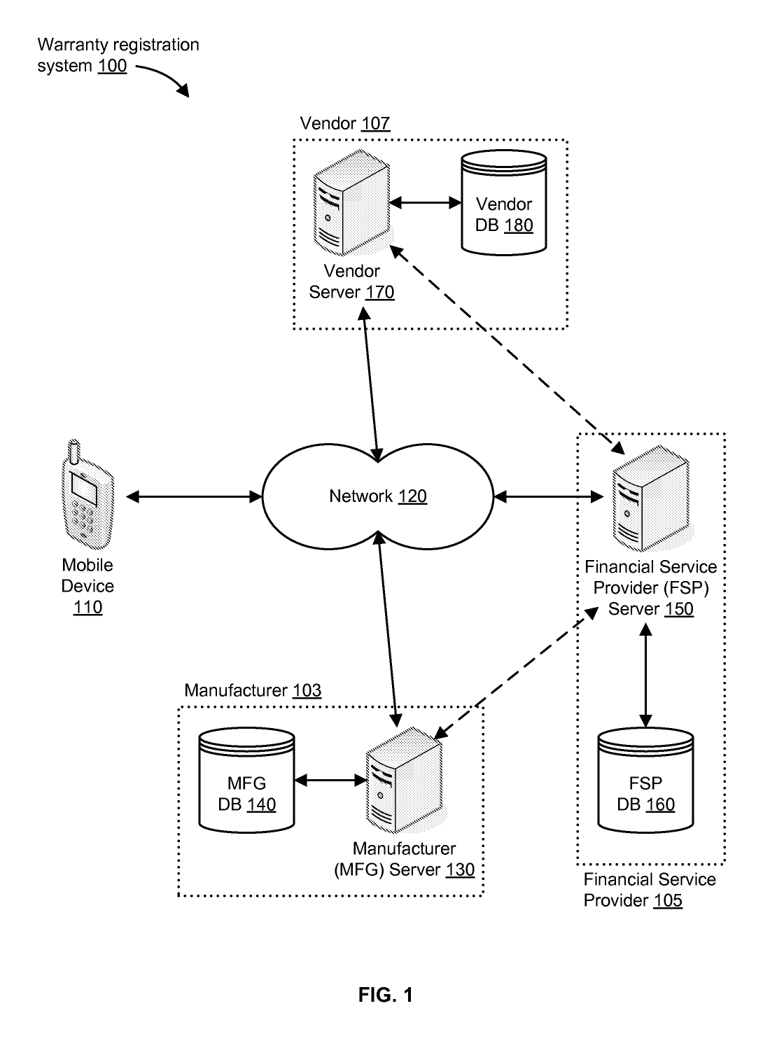

FIG. 1 is a diagram illustrating a system 100 for registering a warranty consistent with disclosed embodiments. The components and arrangements, however, may vary. In one embodiment, a Mobile Device 110 may communicate with Network 120. Mobile Device 110 may be a cellular phone, personal digital assistant, laptop, camera, tablet, music player, or any other device capable of communicating with Network 120. Network 120 may be a wired or wireless network, such as a cellular network, WiFi, WLAN, LAN, Bluetooth™, Internet, or any other suitable communication network.

In some embodiments, a Manufacturer (MFG) server 130 may include a MFG database 140 and can be connected to Network 120. MFG server 130 may be operated by a manufacturer 103, which may be a company or entity that makes and/or sells a product or service having a warranty. MFG server 130 may be implemented in various ways and take the form of a general purpose computer, a server, a mainframe computer, or any combination of these components. In some embodiments, MFG server 130 may include a cluster of servers capable of performing distributed data analysis, e.g., using Google's MapReduce™ framework. MFG database 140 may include a volatile or non-volatile, magnetic, semiconductor, tape, optical, removable, nonremovable, or other type of storage device or computer-readable medium. MFG server 130 may communicate over a link with Network 120. For example, the link may constitute a direct communication link, a LAN, a WAN, or other suitable connection.

In some embodiments, a Financial Service Provider (FSP) server 150 may include a FSP database 160 and can be connected to Network 120. FSP server 150 may be operated by a financial service provider 105, such as, for example, a bank, lender, merchant, credit card provider, and any other entity that provides financial accounts to customers. Financial accounts may include, for example, credit card accounts, checking accounts, savings accounts, loans, investment accounts, and any other type of account relating to financial products. FSP server 150 may be implemented in various ways, and may take the form of a general purpose computer, a server, a mainframe computer, or any combination of these components. FSP database 160 may include a volatile or non-volatile, magnetic, semiconductor, tape, optical, removable, nonremovable, or other type of storage device or computer-readable medium.

In some embodiments, FSP server 150 may include a cluster of servers capable of performing distributed data analysis, e.g., using Google's MapReduce™ framework. FSP server 150 may communicate over a link with Network 120. For example, the link may constitute a direct communication link, a LAN, a WAN, or other suitable connection. FSP server 150 may communicate with Mobile Device 110, MFG server 130, and a vendor server 170 via Network 120, or by direct directional communication link, to send and receive data.

In some embodiments, a Vendor server 170 may include a vendor database 180 and can be connected to Network 120. Vendor server 170 may be operated by a vendor 107 such as a store, salesperson, or distributor that sells products or services. A vendor may also be a website that allows others to buy and sell goods, such as eBay or Paypal. Vendor server 170 may be implemented in various ways, and may take the form of a general purpose computer, a server, a mainframe computer, or any combination of these components. In some embodiments, vendor server 170 may include a cluster of servers capable of performing distributed data analysis, e.g., using Google's MapReduce™ framework. Vendor database 180 may include a volatile or non-volatile, magnetic, semiconductor, tape, optical, removable, nonremovable, or other type of storage device or computer-readable medium. Vendor server 170 may communicate over a link with Network 120. For example, the link may constitute a direct communication link, a LAN, a WAN, or other suitable connection.

Furthermore FSP, MFG, and vendor databases 160, 140, and 180 may be Oracle™ databases, Sybase™ databases or other relational databases, or non-relational databases, such as Hadoop sequence files, HBase or Cassandra. The databases or other files may include, for example, data and information related to the source and destination of a network request, the data contained in the request, etc. Systems and methods of disclosed embodiments, however, are not limited to separate databases.

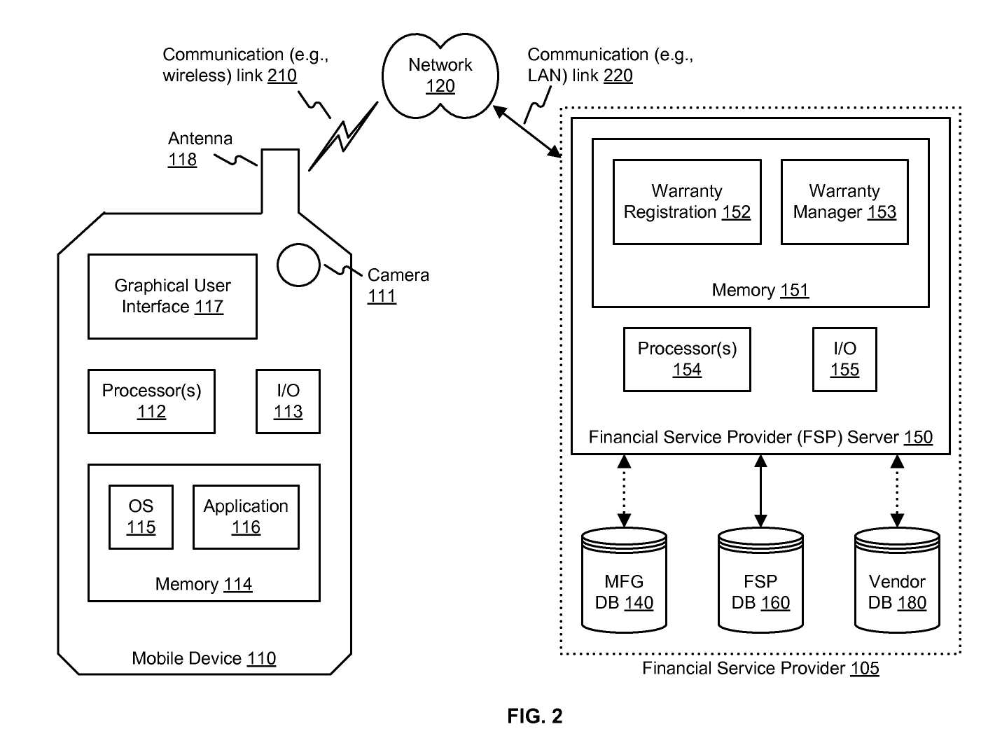

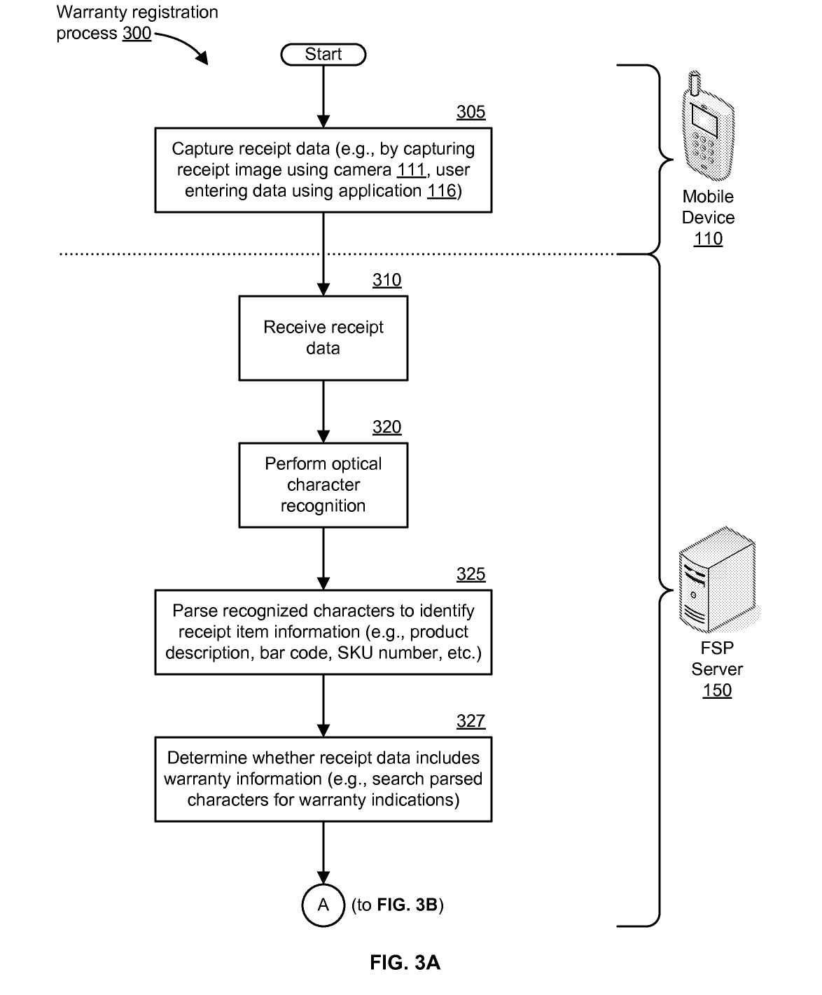

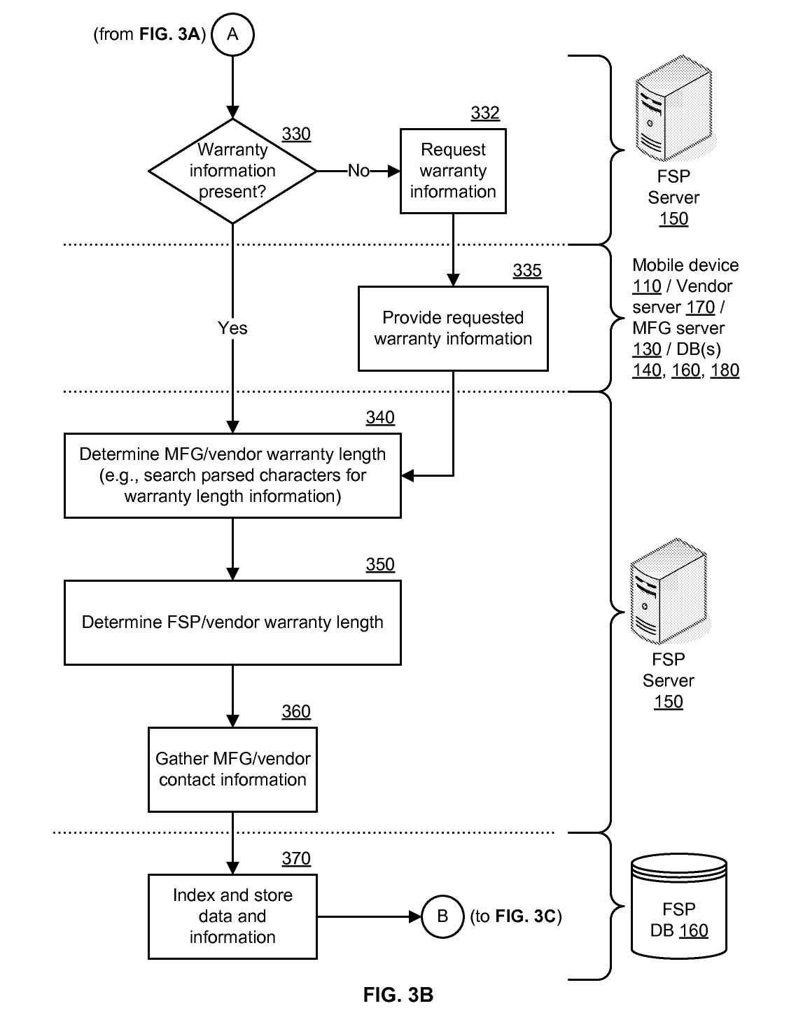

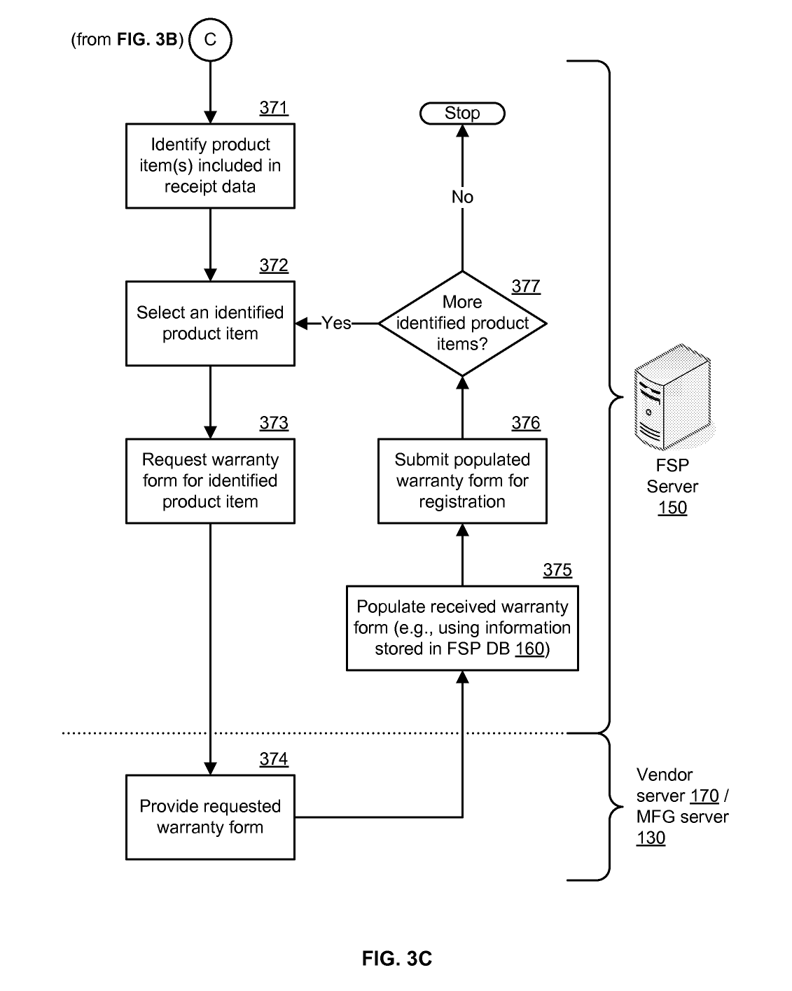

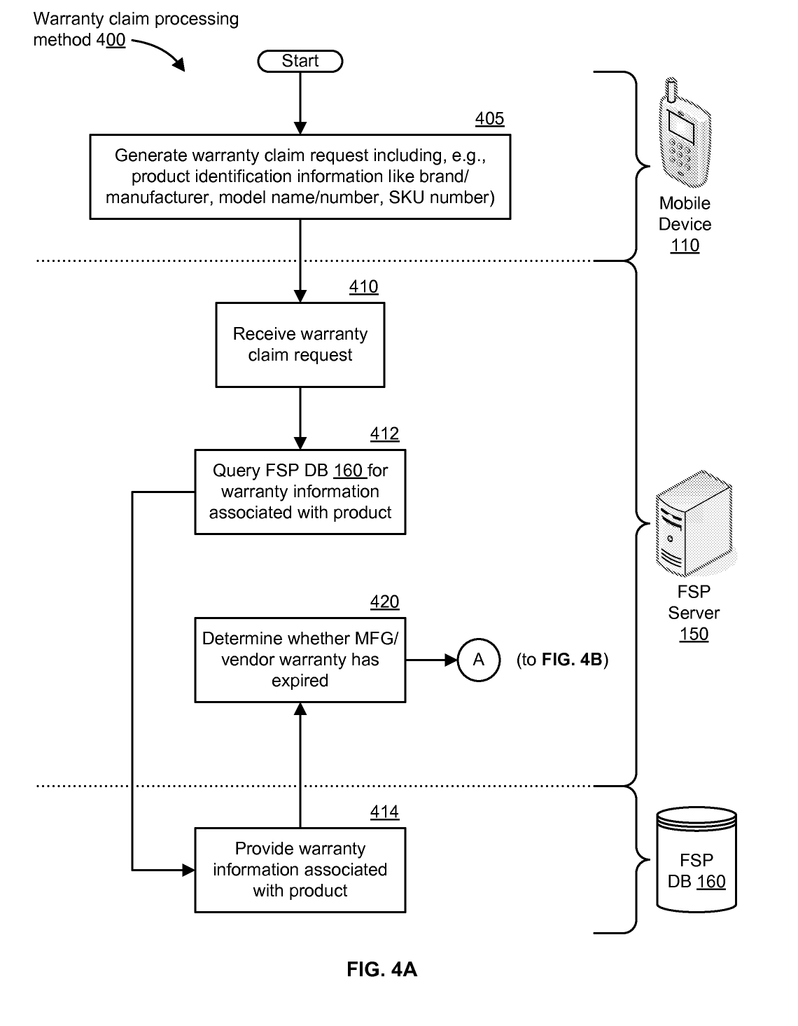

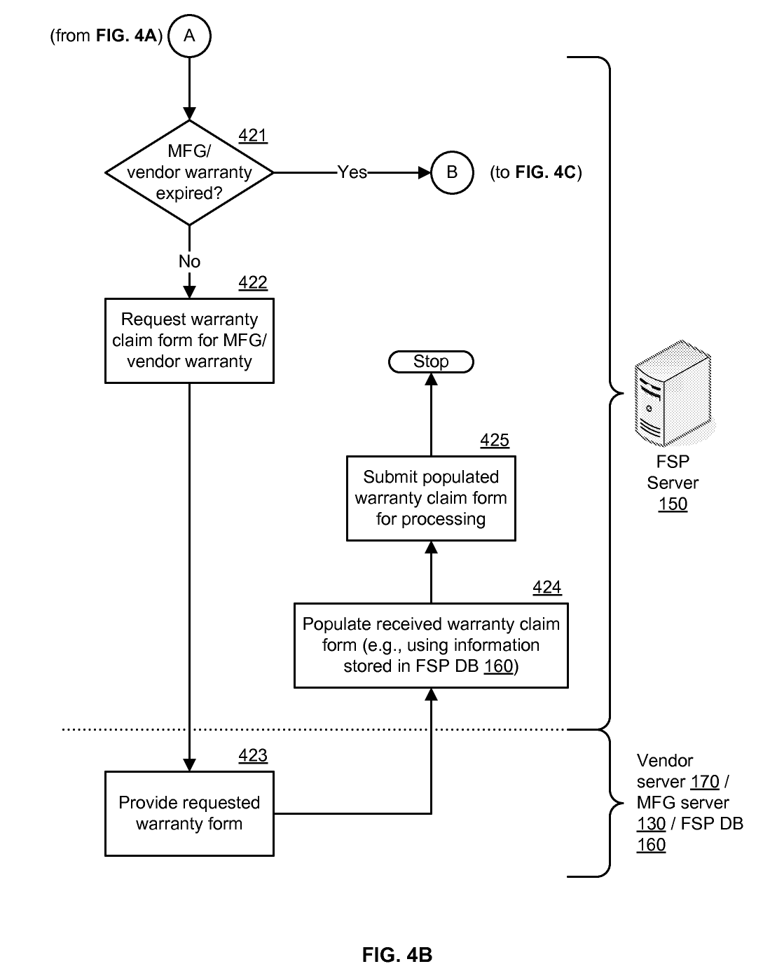

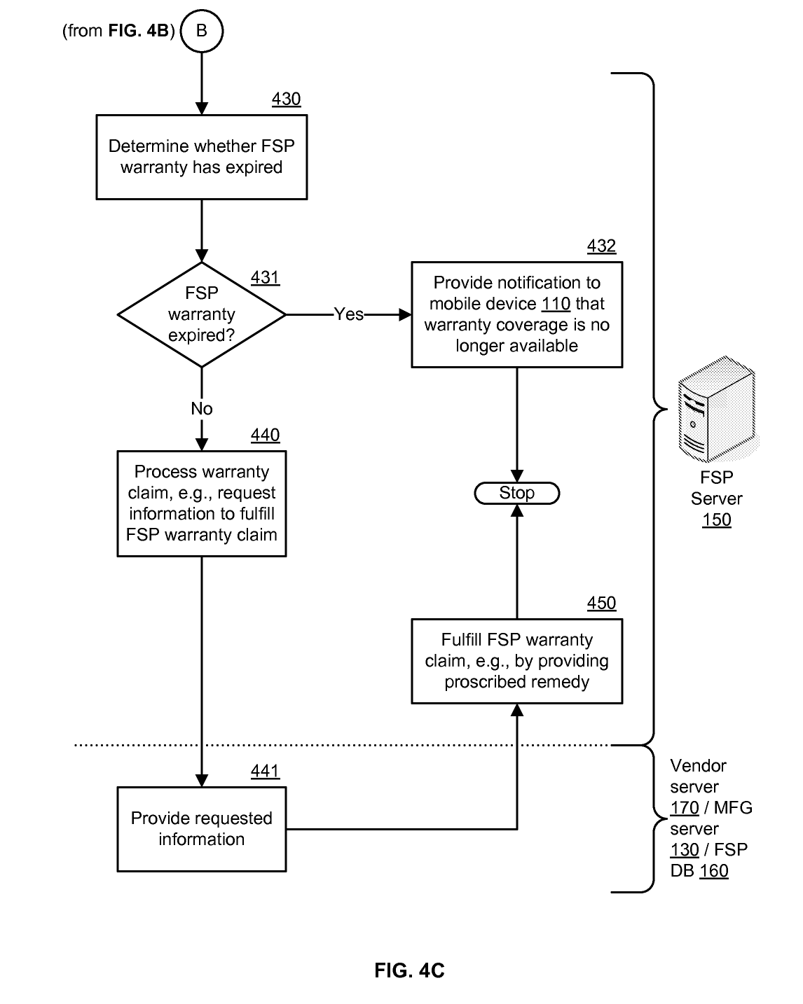

FIG. 2 is a diagram illustrating Mobile Device 110 for communicating over a Network 120 with FSP server 150 consistent with disclosed embodiments, including exemplary system components. The components and arrangement, however, may vary. Mobile Device 110 may include a camera 111, one or more processors 112, input/output (I/O) devices 113, memory 114 having an operating system 115 and application 116, and graphic user interface (GUI) 117. Processor(s) 112 may include one or more known processing devices, such as a microprocessor from the Pentium™ or Xeon™ family manufactured by Intel™, the Turion™ family manufactured by AMD™, or any of various processors manufactured by Sun Microsystems.

Memory 114 may include a volatile or non-volatile, magnetic, semiconductor, tape, optical, removable, nonremovable, or other type of storage device or computer-readable medium. Memory 114 may be also be configured with operating system 115 that performs several functions well known in the art when executed by Mobile Device 110. By way of example, the operating system may be Microsoft Windows™, Unix™, Linux™, Solaris™, or some other operating system. The choice of operating system, and even the use of an operating system, is not critical to any embodiment. In some embodiments, memory 114 may include application/app 116 where app 116 may include one of more sub-programs. In one embodiment, memory 114 may include a program (not shown) that launches a client application on Mobile Device 110 to activate camera 111 and take a photo. In another embodiment, memory 114 may include a program (not shown) that uses I/O devices 113 to send purchaser information to a vendor or manufacturer.

I/O devices 113 may include a microphone, speaker, buttons, physical data ports, wireless data receivers such as near-field communication devices, and any other suitable components for the input or output of information. I/O devices may also include one or more digital and/or analog communication input/output devices that allow mobile device 200 to communicate with other machines and devices, such as FSP Server 150. Mobile device 200 may receive data from external machines and devices and output data to external machines and devices via I/O devices. The configuration and number of input and/or output devices incorporated in I/O devices may vary as appropriate for certain embodiments.

GUI 117 may be implemented via a LCD screen or other suitable display. In some embodiments, GUI 117 may utilize a touch-screen, and may allow data entry directly on the screen in addition to or instead of physical buttons. In some embodiments, Mobile Device 110 may communicate wirelessly (see, e.g., FIG. 2, element 210) using antenna 118 with Network 120. Network 120 may include the Internet.

FSP server 150 may include a server memory 151 that may include a volatile or non-volatile, magnetic, semiconductor, tape, optical, removable, nonremovable, or other type of storage device or computer-readable medium. In some embodiments, server memory 151 may include warranty registration module 152 and warranty manager module 153 that, when executed by server processor 154, perform various procedures, operations, or processes consistent with disclosed embodiments. In one embodiment, server memory 151 may include a program (not shown) that allows FSP system admins to access FSP database 160. In another embodiment, server memory 151 may include a program (not shown) that links other programs stored on server memory 151, allowing them to use a common database such as FSP database 160, provides a common user interface, performs basic bookkeeping tasks, and provides user guidance and help.

FSP server processor 154 may include one or more known processing devices, such as a microprocessor from the Pentium™ or Xeon™ family manufactured by Intel™, the Turion™ family manufactured by AMD™, or any of various processors manufactured by Sun Microsystems.

Input/Output (I/O) devices 155 may include one or more digital and/or analog communication input/output devices that allow FSP server 150 to communicate with other machines and devices, such as MFG server 130 or vendor server 170. FSP server 150 may receive data from external machines, devices, and individuals who are FSP system admins, and output data to external machines and devices via I/O devices. The configuration and number of input and/or output devices incorporated in I/O devices may vary as appropriate for certain embodiments.

FSP database 160 may be in communication over a link 220 with FSP server 150. The link may be a direct wired or wireless connection, or a network connection. FSP server 150 may also be in communication over links with MFG database 140 and vendor database 180. The links may be direct wired or wireless connections, or may be via Network 120. In certain embodiments, FSP server 150 may communicate with MFG database 140 and vendor database 180 via MFG server 130 and vendor server 170, respectively.

FIGS. 3A-C are of a flowchart illustrating a warranty registration process 300 consistent with disclosed embodiments. The steps and order, however, may vary.

Some of the steps may be performed by one or more FSP server processors 154 executing warranty registration module 152.

With reference to FIG. 3A, in some embodiments, receipt data may be received at FSP server 150 (e.g., step 310). The receipt data may be transmitted from an app 116 running on Mobile Device 110. The customer may transmit receipt data from Mobile Device 110 by capturing an image of the receipt using camera 111 (e.g., step 305). Consistent with disclosed embodiments, app 116 may cause the captured image of the receipt to be sent to FSP server 150. Alternatively, receipt data from a paper receipt may be entered manually by the user via user interfaces provided by app 116. If the customer has an electronic receipt stored in a file or email on Mobile Device 110 or elsewhere, receipt data may be transmitted by sending the file via email or other suitable communication medium to FSP server 150. In some embodiments, FSP server 150 may also receive receipt data directly from MFG server 130 or Vendor server 170. In such embodiments, MFG server 130 may transmit an electronic receipt stored in MFG database 140 directly to FSP server 150 when the customer purchases a product or service directly from the manufacturer. Alternatively, vendor server 170 may transmit an electronic receipt stored in vendor database 180 directly to FSP server 150 when the customer purchases a product or service from the vendor. FSP server 150 may receive receipt data in response to a request sent to MFG server 130 or vendor server 170 from app 116 or FSP server 150. Alternatively, MFG server 130 or vendor server 170 may automatically transmit receipt data to FSP server 150 when the customer completes a purchase with their FSP account, such as with a FSP credit card.

In some embodiments, receipt data may be processed by FSP server 150. When a receipt image is received, optical character recognition (OCR) may be performed to convert the digital image data into recognizable numbers, letters, and symbols (e.g., step 320). For example, the FSP server 150 may be capable of executing commands encoded in Hypertext Preprocessor (PHP) scripting language. The FSP server may invoke an OCR software module such as Google open source project Ocropus or Tesseract-OCR using the exec( ) function within PHP. During character recognition, words and numbers may be parsed to recognize information for each item on the receipt, such as product description, bar code, SKU number, inventory number, model name/number, manufacturer/brand, price, warranty length, and any other item information present (e.g., step 325). Additionally, FSP server 150 may recognize information such as receipt number, vendor/store name, store information such as business hours, telephone number, website, and geographical location, date and time of purchase, and tax amount. For example, the FSP server may use a predetermined list of keywords, and may search through the parsed data to find matches for these keywords, e.g., using PHP commands such as strpos( ), strstr( ), preg_match( ) etc.

In some embodiments, FSP server 150 may determine whether received receipt data includes manufacturer/vendor warranty information for the products or services contained in the receipt (e.g., step 327). Such a determination may be made by parsing the recognized characters into words and numbers, and searching the parsed characters for warranty indications such as instances of “warranty,” or a number of days or years written next to the item in the receipt. Warranty information may be distinguished from return policy information by analyzing the context of the parsed words. For example, if “90 days” is recognized in receipt data, surrounding words may be analyzed to determine whether “90 days” refers to a store return policy, or a warranty for the item.

With reference to FIG. 3B, in some embodiments, FSP server 150 may also request warranty information from Mobile Device 110, Vendor server 170, or MFG server 130, as well as associated databases. For example, warranty information may not be present in the received receipt data (see, e.g., step 330, option “No,”), and thus FSP server 150 may request warranty information from one or more entities (e.g., step 332), and the one or more entities may provide the requested warranty information (e.g., step 335). In some embodiments, warranty information may be requested from the customer by sending a message to Mobile Device 110. The customer may then enter warranty information manually for the item(s) in question, or may capture an image of a warranty card for the item. The manually entered information or warranty card image may be transmitted to FSP server 150 via Network 120. In other embodiments, warranty information may be requested from MFG server 130 or vendor server 170. FSP server 150 may send a request to MFG server 130 including item information such as an SKU number, model name/number, price, or any other information recognized from the receipt data that may identify the product or service. The request may be based on item information received from mobile 110 or known from financial transactions observed by FSP server 150. Alternatively, FSP server 150 may send a request to vendor server 170 including information such as a receipt number, inventory number, SKU number, model name/number, price, or any other information recognized from the receipt data that may identify the product or service. In further embodiments, FSP server 150 may perform Internet searches for a SKU number, manufacturer/brand, or model name/number, to obtain warranty information without sending requests to the manufacturer, vendor, or customer.

In some embodiments, warranty information for items may be indexed with item information, and stored in FSP database 160. For example, if FSP database 160 is implemented as an object-oriented database, the FSP database 160 may create a database object corresponding to each item, and may populate the object with warranty information corresponding to the item. Other forms of structured data, e.g., rows/tables, XML/JSON data structures, spreadsheets, tab-separated ASCII text, etc. may also be utilized. FSP server 150 may query FSP database 160 before sending any search inquiries or warranty information requests. Over time, FSP database 160 may store warranty information for many products purchased by different FSP customers, to enable faster, more efficient warranty information retrieval. In other embodiments, FSP server 150 may have direct access to warranty information stored in MFG database 140 and/or vendor database 180.

In some embodiments, the FSP server 150 may determine a warranty length for any manufacturer/vendor warranty for the products or services contained in the receipt (e.g., step 340). As discussed above, character recognition may be performed on received images indicating warranty information. Recognized characters may be parsed into numbers and words. Warranty information received electronically via receipt data or by server/customer request may be parsed into numbers and words. Parsed numbers and words may be analyzed to determine the length of the item manufacturer/vendor warranty, such as “90 days” or “3 years.”

In some embodiments, based on the length of the manufacturer/vendor warranty, the FSP server 150 may determine the length of any extended warranty offered by the financial service provider 105 (e.g., step 350). For example, the extended warranty may be a multiple of the manufacturer/vendor warranty, or may be a predetermined length of time. In certain embodiments, extended or differing warranty coverage may be provided based on the receipt of a payment for warranty offerings.

In some embodiments, the FSP server 150 may gather manufacturer/vendor contact information (e.g., step 360). Contact information may include the website, mailing address, contact emails, telephone number(s), and business hours for the manufacturer and/or vendor. Contact information may be obtained from receipt data character recognition or character recognition performed on received warranty cards or warranty information requests. Consistent with disclosed embodiments, users may enter contact information using app 116, such that sending information to FSP server 150 from a user device becomes associated with the user's contact information. Remaining missing contact information may be obtained by FSP server 150 by sending requests to MFG server 130 and/or vendor server 170, by performing Internet searches for contact information, or by requesting information from the customer via Mobile Device 110.

In some embodiments, after the manufacturer and or vendor contact information has been gathered, all data and information may be indexed and stored in FSP database 160 (e.g., step 370). Stored data may include FSP customer information including name, account number(s), telephone number(s), address(es), and any demographic data provided to FSP server 150. FSP customer information may be input via Mobile Device 110 (step not shown), or may be stored from previous communications with the FSP customer.

Stored data may also include receipt data, warranty information, any received images, vendor and MFG contact information. The stored data may be indexed to associate information regarding products or services and relevant warranty and contact information with particular FSP customers. Additionally, the extended warranty time may be stored in FSP database 160, including the time length of the warranty and the expiration date. As previously mentioned, the amount of stored data may increase. As a result, missing warranty information for a product or contact information for a MFG or vendor may be retrieved directly from searching FSP database 160, thus increasing efficiency and accuracy.

With reference to FIG. 3C, in some embodiments, FSP server 150 may register the MFG or vendor warranty for the customer (not shown in figures). For example, FSP server 150 may identify any products or services included in the receipt data (e.g., step 371), using character recognition and parsing techniques as discussed above. FSP server 150 may obtain the necessary warranty card(s) for each item recognized (see, e.g., steps 372, 377) in receipt data by sending a request to the MFG server 130 or vendor server 170 for a warranty form for an item identified by SKU, model name/number, or other identifying information (e.g., step 373). Alternatively, warranty forms may be obtained from images transmitted from customer Mobile Device 110, to which FSP server 150 may apply the optical character recognition and parsing techniques described previously. Upon receiving the warranty form from the appropriate entity (see, e.g., step 374), FSP server 150 may populate the warranty form fields using information stored in FSP database 160 (e.g., step 375). FSP server 150 may then submit the warranty form to complete warranty registration (e.g., step 376). In certain embodiments, warranty registration data may be transmitted directly from FSP server 150 to MFG server 130 or vendor server 170 of manufacturers or vendors who have partnered with FSP. In such embodiments, the customer would not have to take any additional steps to register the manufacturer/vendor warranty after FSP server 150 receives receipt data.

An FSP customer may view and manage their warranties on Mobile Device 110. Warranty manager 153 running on FSP server 150 may format data stored in FSP database 160, and transmit formatted data to Mobile Device 110 for display on GUI 117. Warranty manager 153 may allow the FSP customer to view their purchase history, warranties for purchased products and services, MFG/vendor warranty expiration dates and length of time remaining, and extended warranty expiration dates and length of time remaining (not shown in figures).

FIGS. 4A-C are of a flowchart illustrating a warranty claim process consistent with disclosed embodiments. The steps and order, however, may vary. The steps may be performed by one or more FSP server processors 154 executing warranty manager 153.

With reference to FIG. 4A, in some embodiments, Warranty manager (e.g., FIG. 2, element 153) may receive a request for a warranty claim. The request may be transmitted from Mobile Device 110, or input manually by a FSP system admin in response to a conversation with the FSP customer. The request may include information identifying the product, such as brand/manufacturer, model name/number, and SKU number. In some embodiments, the request may include information identifying the transaction, such as receipt number, date and time of purchase, or location of purchase. For example, the information included in the request may be in the form of an image captured by Mobile Device 110 (e.g., step 405): a customer may capture image(s) of the product model name/number, SKU number, etc., as appearing on the product, product packaging, or a receipt, using the Mobile Device 110. The Mobile Device 110 may send the captured image to warranty manager 153. Warranty manager 153 may utilize optical character recognition and parsing procedures described previously to extract information relevant to the request from the captured image(s).

In some embodiments, Warranty manager 153 may determine whether the MFG or vendor warranty has expired (e.g., step 420). For example, Warranty manager 153 may search FSP database 160 for the warranty information associated with the particular product, in conjunction with the FSP customer to determine whether the expiration date has passed (e.g., steps 412, 414).

With reference to FIG. 4B, in some embodiments, if the MFG/vendor warranty expiration date has not passed (e.g., step 421, option “No”), and the warranty is still effective, Warranty manager 153 may provide claim information to the FSP customer. Claim information may include providing a warranty claim form, phone number, or address for the manufacturer or vendor. Warranty claim forms may be obtained automatically by FSP server 150 by sending a request to MFG server 130 or vendor server 170 (e.g., steps 422-423), or by performing an Internet search to retrieve the form. In some embodiments, obtained warranty claim forms may be stored in FSP database 160, to increase efficiency for future warranty claim requests. FSP server 150 may populate the warranty claim form fields with all known information stored in FSP database 160 (e.g., 424). A completed warranty claim form may be transmitted directly from FSP server 150 to MFG server 130 or vendor server 170 for processing (e.g., 425). Alternatively, a warranty claim form that is complete or incomplete may be transmitted to user device 110 to allow FSP customer to file the claim.

With reference to FIG. 4C, in some embodiments, if the MFG/vendor warranty has expired (e.g., FIG. 4B, step 421, option “Yes”), Warranty manager 153 may determine whether the extended warranty provided by the FSP has expired (e.g., step 430). Warranty manager 153 may search FSP database 160 for the extended warranty information associated with the particular product, in conjunction with the FSP customer to determine whether the expiration date of the extended warranty has passed.

In some embodiments, if the extended warranty provided by the FSP has also expired (e.g., step 431, option “Yes”), Warranty manager 153 may return a notification to user device 110 that warranty coverage is no longer available (e.g., step 432), and the process may end at this point.

If the extended warranty provided by the FSP has not expired (e.g., step 431, option “No”), FSP server 150 may proceed to process the warranty claim. FSP server 150 may search FSP database 160 to determine the price of the item (e.g., steps 440-441). FSP server 150 may also determine the remedies available in the MFG/vendor warranty, by sending a request to MFG server 130 or vendor server 170, performing an Internet search for warranty remedies, or performing character recognition of received receipt and warranty data. In some situations, FSP server 150 may notify a FSP system admin that the terms or remedies of the product warranty are unclear, and require review by an individual.

In some embodiments. FSP server 150 may fulfill the warranty claim (e.g., step 450), by providing the proscribed remedy such as ordering replacement items, or refunding a portion or the entire purchase price. Replacement items may be ordered by FSP 150 by sending a request via Network 120 to MFG server 130 or vendor server 170. The request may include the SKU number, model name/number, or other identifying information, as well as contact information and mailing address for the FSP customer. Alternatively, refunds may be provided to the FSP customer by crediting money to the customer's account, or sending a reimbursement check. It is to be understood that other remedies may be available depending on the particular warranty terms, or terms outlined by the FSP.

Methods, systems, and articles of manufacture consistent with disclosed embodiments are not limited to separate programs or computers configured to perform dedicated tasks. For example, server memory 151 may be configured with modules such as warranty manager 153 that performs several functions when executed by processor 154. For another example, server memory 151 may include warranty registration module 152 that performs the functions of the warranty registration analysis system, or warranty registration module 152 could comprise multiple programs. Moreover, processor 154 may execute one or more programs located remotely from FSP server 150. For example, FSP server 150 may access one or more remote programs that, when executed, perform functions related to disclosed embodiments. Processor 154 may also execute one or more programs that connect FSP server 150 to an external server or third party entity that performs functions related to disclosed embodiments. For example, FSP server 150 may employ a third party to manage FSP customer warranty information, gather MFG and vendor contact information, warranty claim forms, process, and fulfill claims.

For another further example, processor 112 of Mobile Device 110 may execute one or more programs or web applications located remotely from mobile device. For example, Mobile Device 110 may access one or more remote programs that, when executed, perform functions related to disclosed embodiments.

In some embodiments, programs that perform functions of embodiments of the present disclosure may be obtained from an application store (app store). A non-transitory computer readable medium in this scenario may store instructions that, when executed by one or more hardware processors, provides the systems and methods in accordance with embodiments of the present disclosure as described above. The non-transitory computer readable medium may exist in a server that connects to a device, which in certain embodiments is Mobile Device 110, e.g. a smartphone, a computer tablet, a GPS, a personal digital assistant, a wearable computing device, etc. The mobile device may be owned or otherwise associated with a user. The connection between the mobile device and the server may occur through the Internet or other communication protocols, e.g. Universal Serial Bus (USB), Bluetooth, hardware plug-ins, WiFi and other wireless local area network (WLAN) protocols, and 3G/4G/LTE and other wide area network (WAN) protocols. The app store provides an interface through which the user may obtain a copy of the instructions stored on the non-transitory computer readable medium existing on the server that when executed by one or more hardware processors provides the systems and/or methods in accordance with the present disclosure described above. The user may interact with the app store using an interface executed on the mobile device. In the present scenario, the user may request a copy of the instructions stored in the app store using mobile device; the instructions may then be transmitted by the app store from server to the mobile device. In this manner, the mobile device may itself comprise a non-transitory computer readable medium comprising instructions that when executed by one or more hardware processors provides the systems and methods in accordance with embodiments of the present disclosure described above. Upon execution of the instructions by one or more hardware processors, the mobile device may essentially become a system in accordance with the present disclosure, capable of performing the steps of a method in accordance with the present disclosure.

Although the invention is contemplated primarily in the context of product warranty registration, it can also be applied to other aspects of consumer products and services. By collecting detailed customer purchase data such as product SKU numbers, brands/manufacturers, stores/vendors, time and place of product purchases, and individual item prices, financial service providers may apply the embodiments of the present disclosure to other services. Indeed, those skilled in the art will appreciate that the present disclosure can be applied to distribution of coupons, sales, discounts, financing offers, product/service advertisement and recommendations, and other incentives that may be offered to customers.

It is to be understood that both the foregoing general description and the following detailed description are exemplary and explanatory only and are not restrictive of the invention, as claimed.

What is claimed is:

1. A warranty management system, comprising:
one or more processors; and
one or more memory devices storing processor-executable instructions comprising instructions for:
receiving, from a mobile device, a product purchase receipt image;
extracting, using optical character recognition, product purchase data from the product purchase receipt image;
identifying, by parsing the product purchase data, one or more product warranty terms including a product warranty period;
generating a product warranty data structure comprising the one or more product warranty terms; and
storing the product warranty data structure in a memory device.

2. The system of claim 1, wherein the generated product warranty data structure further comprises a customer identifier.

3. The system of claim 1, the one or more memory devices further storing instructions for:
generating a product warranty index using the one or more product warranty terms; and
storing the product warranty index in a memory device for efficient warranty information retrieval.

4. The system of claim 3, wherein the product warranty index is configured to be queried using a customer identifier.

5. The system of claim 1, the one or more memory devices further storing instructions for:
determining an extended warranty period using the product purchase data and the product warranty time;
generating an extended warranty data structure using the extended warranty period; and
storing the extended warranty data structure in a memory device.

6. The system of claim 5, wherein a product warranty associated with the one or more product warranty terms and an extended warranty associated with the extended warranty period are provided by separate warranty providers.

7. The system of claim 6, the one or more memory devices further storing instructions for:
receiving, from a computer associated with a product warranty provider, product warranty provider contact data;
wherein the generated product warranty data structure further comprises the product warranty provider contact data;
receiving, from a computer associated with an extended warranty provider, extended warranty provider contact data; and
wherein the generated extended warranty data structure further comprises the extended warranty provider contact data.

8. A processor-implemented warranty management method, comprising:
receiving, from a mobile device, a product purchase receipt image;
extracting, using optical character recognition by one or more processors, product purchase data from the product purchase receipt image;
identifying, by parsing the product purchase data by the one or more processors, one or more product warranty terms including a product warranty period;
generating, via the one or more processors, a product warranty data structure comprising the one or more product warranty terms; and
storing the product warranty data structure in a memory device.

9. The method of claim 8, wherein the generated product warranty data structure further comprises a customer identifier.

10. The method of claim 8, further comprising:
generating a product warranty index using the one or more product warranty terms; and
storing the product warranty index in a memory device for efficient warranty information retrieval.

11. The method of claim 10, wherein the product warranty index is configured to be queried using a customer identifier.

12. The method of claim 8, further comprising:
determining, via the one or more processors, an extended warranty period using the product purchase data and the product warranty time;
generating, via the one or more processors, an extended warranty data structure using the extended warranty period; and
storing the extended warranty data structure in a memory device.

13. The method of claim 12, wherein a product warranty associated with the one or more product warranty terms and an extended warranty associated with the extended warranty period are provided by separate warranty providers.

14. The method of claim 13, further comprising:
receiving, from a computer associated with a product warranty provider, product warranty provider contact data;
wherein the generated product warranty data structure further comprises the product warranty provider contact data;
receiving, from a computer associated with an extended warranty provider, extended warranty provider contact data; and
wherein the generated extended warranty data structure further comprises the extended warranty provider contact data.

15. A warranty claim processing system, comprising:
one or more processors; and
one or more memory devices storing processor-executable instructions comprising instructions for:
receiving a warranty claim request;
extracting product and customer identification information from the warranty claim request;
querying a database for manufacturer or vendor product warranty data related to the product and customer identification information;
determining whether a manufacturer or vendor product warranty is effective, based on a result of the database query for the manufacturer or vendor product warranty data;
generating a populated warranty claim form using the extracted product and customer identification information and the result of the database query; and
providing the populated warranty claim form to a computer associated with a warranty provider.

16. The system of claim 15, the one or more memory devices further storing instructions for:
determining that the manufacturer or vendor product warranty is effective, based on the result of the database query;
wherein the warranty provider is a manufacturer or vendor warranty provider.

17. The system of claim 15, the one or more memory devices further storing instructions for:
determining that the manufacturer or vendor product warranty is ineffective, based on the result of the database query;
querying the database for extended warranty data related to the product and customer identification information; and
determining that an extended warranty is effective, based on a result of the database query for the extended warranty data;
wherein the warranty provider is an extended warranty financial service provider.

18. The system of claim 15, the one or more memory devices further storing instructions for:
extracting an image from the warranty claim request; and
obtaining, using optical character recognition, request data from the image;
wherein product and customer identification information is extracted from the warranty claim request by parsing the request data.

19. The system of claim 18, wherein the warranty claim request is received from a mobile device.

20. The system of claim 19, wherein the image is captured by the mobile device.

21. The system of claim 20, wherein the image captured by the mobile device is that of a product bar code.
